(19) United States
(12) Patent Application Publication
(10) Pub. No.: US 2012/0119582 A1
(43) Pub. Date: May 17, 2012

(54) SERIES-PARALLEL SWITCHING SYSTEM, ELECTRIC POWER SUPPLY DEVICE, ELECTRIC POWER SUPPLY CONTROL DEVICE, AND SERIES-PARALLEL SWITCHING METHOD

(76) Inventor: Shigeru TAJIMA, Kanagawa (JP)

(21) Appl. No.: 13/288,625

(22) Filed: Nov. 3, 2011

(30) Foreign Application Priority Data
Nov. 12, 2010 (JP) 2010-254197

(51) Int. Cl. H02J 4/00

(52) U.S. Cl. 307/71

(57) ABSTRACT

A series-parallel switching system includes two or more electric power supply sources; two or more first switches; and two or more second switches, wherein pairs of two or more first switches and two or more second switches are each independently switched, the two or more electric power supply sources are connected to a bus line that includes at least a first bus line and a second bus line, and by switching over the first switches and the second switches using the switch switching portion, the first switches and the second switches are connected to the first bus line and the second bus line or are separated from the first bus line and the second bus line, and the connection of the electric power supply device is changed over to series and parallel.

### BACKGROUND

The present disclosure relates to a series-parallel switching system, an electric power supply device, an electric power supply control device, and a series-parallel switching method.

Series and parallel connections of an electric power source or a load are the basis of an electric circuit. In a passive load, the series and parallel connections may be realized by the corresponding electric wiring without accompanying difficulty in principle. Meanwhile, it is dangerous if the voltage or the current capacity is not considered in the electric power source, and it is difficult to perform the simple series and parallel connections.

For example, in the case of a parallel connection of a battery, a condition in which the output voltages of each battery connected to each in parallel are identical to each other or a condition in which the kinds (a maker and a lot) of the battery are identical to each other is necessary. The reason is that when the kinds of each battery are different from each other, charging and discharging characteristics are different from each other, even if the voltages are initially identical to each other, an voltage imbalance occurs over time, which causes an adverse effect in which any battery charges another battery, and stress is applied to only a particular battery, or the like.

In the series connection, the overall current capacities connected in series are determined by the smallest value, and if the current capacities of each element are not identical to each other, it is difficult to perform an effective connection. However, by aligning the electrical characteristics, or by putting measures such as the control of the current distribution to each element (in the case of parallel) and making the current capacities identical to each other (in the case of series), the electric power source is also able to perform the series and parallel connections and such a switch-over, and those are really used.

### SUMMARY

However, in the switch-over of the series and parallel connection of the electric power source of the related art, there is a problem in that many wirings are necessary. Although it is specifically described later, for example, when showing an example of a motor as a load that controls the electric power similarly to an electric power source, in this case, even in the case of trying to switch between series and parallel for four motors, complicated wirings are necessary. In addition, all the wirings are electric power wirings, and wiring suitable for the capacity of the motor is necessary.

It is desirable to provide a new and improved series-parallel switching system, an electric power supply device, an electric power supply control device, and a series-parallel switching method that can realize the series-parallel switching of the electric power source by a simple and easy configuration.

According to an embodiment of the present disclosure, there is provided a series-parallel switching system which includes two or more electric power supply sources; two or more first switches that are provided so as to correspond to the respective electric power supply sources and connect the two or more electric power supply sources to each other in series; and two or more second switches that are provided so as to correspond to the respective electric power supply sources and connect the two or more electric power supply sources to each other in parallel, wherein pairs of two or more first switches and two or more second switches are each independently switched, the two or more electric power supply sources are connected to a bus line that includes at least a first bus line each commonly connected to an electric power input side of each electric power supply source and a second bus line each commonly connected to an electric power output side of each electric power supply source, and, by switching over the first switches and the second switches using the switch switching portion, the first switches and the second switches are connected to the first bus line and the second bus line or are separated from the first bus line and the second bus line, and the connection of the electric power supply device is changed over to series and parallel.

In the series-parallel switching system, the electric power supply source may further include a switch switching instruction portion that instructs the switching of the first switches and the second switches.

In the series-parallel switching system, the switch switching instruction portion may further include a modem which executes the communication of information on the switching of the first switches and the second switches in the electric power supply source, the modem may notify information received by the communication of information on the switching, and the switch switching instruction portion may instruct the switching of the first switches and the second switches based on information received from the modem.

The modem may receive information on the switching superimposed on the electric power.

The bus line may further include a third bus line that connects the output side with the input side between the electric power supply sources, and the first switches and the second switches may be provided on the third bus line.

The series-parallel switching system may further include an electric power supply control device that executes the communication of information on the switching between the series-parallel switching system and the modem.

The electric power supply source may be a solar battery module.

Furthermore, according to another embodiment of the present disclosure, there is provided an electric power supply device which includes a first switch for being connected to another electric power supply source in series; a second switch for being connected to another electric power supply source in parallel; and a modem which executes the communication of information on the switching of the first switch and the second switch, wherein pairs of two or more first switches and two or more second switches are each independently switched, another electric supply source is connected to a bus line that includes at least a first bus line each commonly connected to an electric power input side of another electric power supply source and a second bus line each commonly connected to an electric power output side of another electric power supply source, the modem notifies information received by the communication of information on the switching to the switch switching instruction portion, and the switch switching instruction portion instructs the switching of the first switches and the second switches based on information received from the modem.

The modem may receive information on the switching superimposed on the electric power.

The electric power supply source may be a solar battery module.

Furthermore, according to still another embodiment of the present disclosure, there is provided an electric power supply control device which includes a first switch that is provided so as to correspond to each electric power supply source for being connected to another electric power supply source in series; a second switch that is provided so as to correspond to each electric power supply source for being connected to another electric power supply source in parallel; a switch switching instruction portion that instructs the switching of the first switch and the second switch; and a modem which executes the communication of information on the switching of the first switch and the second switch, wherein the communication of information on the switching is executed between the electric power supply control device and an electric power supply device connected to a bus line that includes at least a first bus line each commonly connected to an electric power input side of another electric power supply source and a second bus line each commonly connected to an electric power output side of another electric power supply source.

The electric power supply control device may superimpose information on the switching on the electric power to perform the communication between the electric power supply control device and the modem.

Furthermore, according to still another embodiment of the present disclosure, there is provided a series-parallel switching method in the series-parallel switching system which includes two or more electric power supply sources; two or more first switches that are provided so as to correspond to the respective electric power supply sources and connect the two or more electric power supply sources to each other in series; and two or more second switches that are provided so as to correspond to the respective electric power supply sources and connect the two or more electric power supply sources to each other in parallel, wherein pairs of two or more first switches and two or more second switches are each independently switched, the two or more electric power supply sources are connected to a bus line that includes at least a first bus line each commonly connected to an electric power input side of each electric power supply source and a second bus line each commonly connected to an electric power output side of each electric power supply source, the method includes series-parallel switching that switches the connection to the electric power supply device between series and parallel by switching over the first switches and the second switches using the switch switching portion.

According to the embodiments of the present disclosure as mentioned above, it is possible to provide a new and improved series-parallel switching system, an electric power supply device, an electric power supply control device, and a series-parallel switching method that can realize the series-parallel switching of the electric power source by a simple and easy configuration.

### BRIEF DESCRIPTION OF THE DRAWINGS

FIG. 1 is an explanatory diagram that shows a method of series-parallel connection of the related art;

FIG. 2 is an explanatory diagram that shows an configuration example of a series-parallel switching system according to a first embodiment of the present disclosure;

FIG. 3 is an explanatory diagram that shows a case where electric power sources are connected to each other in parallel in the series-parallel switching system according to the first embodiment of the present disclosure shown in FIG. 2;

FIG. 4 is an explanatory diagram that shows a case where electric power sources are connected to each other in series in the series-parallel switching system according to the first embodiment of the present disclosure shown in FIG. 2;

FIG. 5 is an explanatory diagram that shows a case where electric power sources V1 and V2 are connected to each other in series, electric power sources V3 and V4 are connected to each other in series, electric power sources V5 and V6 are connected to each other in series, and the electric power sources connected to each other in series are connected to each other in parallel in the series-parallel switching system according to the first embodiment of the present disclosure shown in FIG. 2;

FIG. 6 is an explanatory diagram that shows a case where electric power sources V1, V2, V3 are connected to each other in series, electric power sources V4, V5, and V6 are connected to each other in series, and the electric power sources connected to each other in series are connected to each other in parallel in the series-parallel switching system according to the first embodiment of the present disclosure shown in FIG. 2;

FIG. 7 is an explanatory diagram that extracts and shows one electric power source included in the series-parallel switching system according to the first embodiment of the present disclosure shown in FIG. 2;

FIG. 8 is an explanatory diagram showing that the components shown in FIG. 7 are separated from a bus line to clarify a connection point;

FIG. 9 is an explanatory diagram that shows a configuration of a bus line side in the series-parallel switching system according to the first embodiment of the present disclosure;

FIG. 10 is an explanatory diagram that shows a configuration example of a series-parallel switching system according to a second embodiment of the present disclosure;

FIG. 11 is an explanatory diagram that shows the series-parallel switching system according to the second embodiment of the present disclosure shown in FIG. 10 by a form of a unit of a bus line and an electric power source connected to the bus line;

FIGS. 12A to 12D are explanatory diagrams that show the series-parallel connection of the series-parallel switching system according to the second embodiment of the present disclosure;

FIGS. 13A to 13C are explanatory diagrams that show a configuration example of a series-parallel switching system according to a third embodiment of the present disclosure;

FIG. 14 is an explanatory diagram that shows a configuration example of a series-parallel switching system according to a fourth embodiment of the present disclosure;

FIG. 15 is an explanatory diagram that shows an inner portion of a unit (a battery device), which is a component of the series-parallel switching system according to the fourth embodiment of the present disclosure shown in FIG. 14, by a function block;

FIGS. 16A to 16E are explanatory diagrams that show a configuration example of a series-parallel switching system according to a fifth embodiment of the present disclosure; and

FIG. 17 is an explanatory diagram that shows a bus line and a unit structure of the series-parallel switching system according to the fifth embodiment of the present disclosure.

### DETAILED DESCRIPTION OF EMBODIMENTS

Hereinafter, preferred embodiments of the present disclosure will be described in detail with reference to the drawings. In addition, in the description and the drawings, the components having substantially the same functional configuration are denoted by the same reference numerals, and the overlapped description will be omitted.

In addition, the description will be made by the following order:
1. Series-Parallel Switching of Related Art
2. First Embodiment of the Present Disclosure
3. Second Embodiment of the Present Disclosure
4. Third Embodiment of the Present Disclosure
5. Fourth Embodiment of the Present Disclosure
6. Fifth Embodiment of the Present Disclosure
7. Conclusion

### 1. Series-Parallel Switching of Related Art

Firstly, before describing the preferred embodiments of the present disclosure, a series-parallel switching of an electric power source widely used in the related art and the problem thereof will be described.

Since a permanent series-parallel switching connection is performed in view of the physical characteristics of a device used in the design, such a wiring is not permanently changed.

Meanwhile, in the case of dynamically switching and using the series and the parallel, the wiring thereof becomes a great problem. In a classic example, there is a direct current electric locomotive that is controlled by a resistance control and the series-parallel switching of the motor. In addition, in a modern direct current electric locomotive, commonly, a motor terminal voltage is continuously raised from zero using a semiconductor, and the series-parallel control mentioned herein is not used.

For example, in a locomotive having 6 driving wheels used in Japan, one DC motor is provided for each shaft and a total of six motors and used. Meanwhile, an overhead line voltage is generally direct current of 1,500 V, and it is necessary to control the voltage applied to the DC motor when shifting from the stop state to the starting state or increasing the speed. In the case of AC electrification, a transformer is provided in the interior of the locomotive and a large amount of voltage can be easily provided, but the voltage switching of the direct current was extremely difficult (in an era without semiconductors).

For this reason, in such a DC electric locomotive, all six motors are connected to each other in series during startup and a resistor is inserted in series to start the rotation. That is, the existing DC electric locomotive divides the supply voltage of the electric power source by the terminal voltage of the motor, that is to say, by six. In addition, herein, the motors have completely the same characteristics, and the speed between the respective motors is identical to each other. The resistor performs electric current limitation to the motor. When the motor starts to rotate, a certain number of revolutions is obtained by a reverse voltage of the motor, and when continuously causing the electric current to flow in the resistor, the heating is too great, and thus, the resistance gradually reduces, and the 6 motors are simply connected to each other in series.

Furthermore, in order to speed up the motor, three series pairs are connected to each other in parallel (at this time, the resistor may be jointly used). Moreover, in order to further speed up the motor, the three pairs of two series are connected to each other in parallel, and finally, all of six motors are switched over in parallel (when further speeding up the motor, the control of reducing the field current of the DC motor is performed, but the control is not involved herein). That is, the connections of the six motors are switched between series and parallel, a switch for the switching is prepared, and the DC electric locomotive runs while switching the switch through the control of a driver.

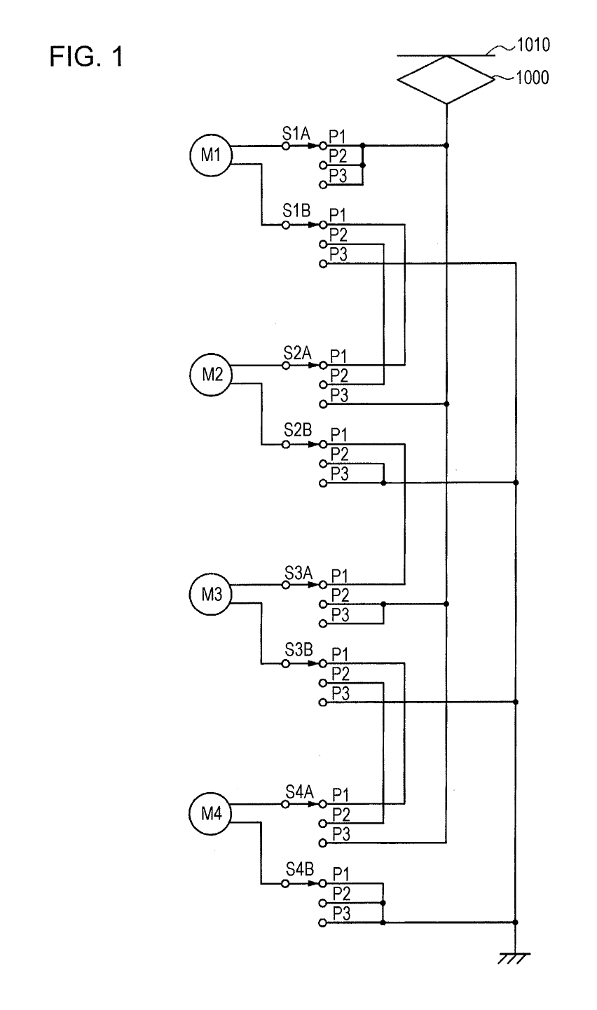

FIG. 1 is an explanatory diagram that shows a method of switching the series-parallel connection of the related art. In order to simplify the description, FIG. 1 shows the switching of the series-parallel connection in the case of four motors. Furthermore, FIG. 1 also shows a pantograph 1000 and an electric wire 1010. In FIG. 1, the motor realizes a three-state connection by switches SnA and SnB (n=1, 2, 3, and 4). In addition, in a so-called resistance control, there is a necessity for the series resistance, but this is omitted from FIG. 1.

The switches SnA and SnB are provided with terminals P1, P2, and P3, and the connections of motors M1, M2, M3, and M4 are switched over by the switching of the terminals P1, P2, and P3 as below.

P1: M1, M2, M3, and M4 are in series

P2: parallel of (M1 and M2 series) and (M3 and M4 series)

P3: M1, M2, M3, and M4 are all in parallel

However, as is evident from FIG. 1, in such switching, complicated wirings shown in FIG. 1 are necessary for only four motors. Furthermore, all of the wirings are electric power wirings, and wirings suitable for the capacity of the motor are necessary.

Furthermore, when considering the case of charging the battery using natural energy such as a solar battery, in order to effectively use the characteristic thereof, the technique of a so-called MPPT (Maximum Power Point Tracking) is used. The MPPT controls the load (for example, a battery charger) so as to track the maximum value of the output electric power of the solar battery which depends on the weather.

Meanwhile, the solar battery varies greatly due to the weather in the amount of electric power generated, and particularly, on a cloudy day, the evening or the like, the output voltage from a single panel reaches an unacceptable range. In such a case, when connecting the solar battery in series, the voltage can at least be raised. In this case, the electric current may be very small compared to in clear weather, but setting the voltage high is suitable for switching the electric power.

For example, there are ten solar batteries, it is difficult to raise and use the voltage of the batteries by an output of 1 V per sheet, but when connecting all of them in series, the voltage thereof becomes 10 V, and the batteries are easily used. Meanwhile, when the sunlight is sufficient, if 10 V can be obtained per sheet, in the case of connecting the five sheets series in parallel, 50 V can be expected. If the voltage is 50 V, the risk of electric shock can nearly be avoided, whereby the stability is increased in the case of 100 V (when connecting ten 10 V solar batteries in series).

However, in the switching by the switch as shown in FIG. 1, the wiring thereof is complicated, and when trying to increase or decrease the solar battery in the middle or the like, repairing the wiring or the like is extremely difficult.

Thus, in an embodiment of the present disclosure described later, a series-parallel switching system capable of easily switching the connection form of a plurality of electric power sources will be described without complicating the wiring.

### 2. First Embodiment of the Present Disclosure

As mentioned above, when the series-parallel of the solar battery with the same specification is easily switched, the wiring or the like is simplified and the merit thereof is great. For this, rather than a method where individual wirings are focused on one point as shown in FIG. 1, preparing a bus line commonly connected to an input side and an output side of each solar battery and connecting the solar battery to the bus line is suitable. Hereinafter, a configuration example having the configuration of the series-parallel switching system according to a first embodiment of the present disclosure will be described.

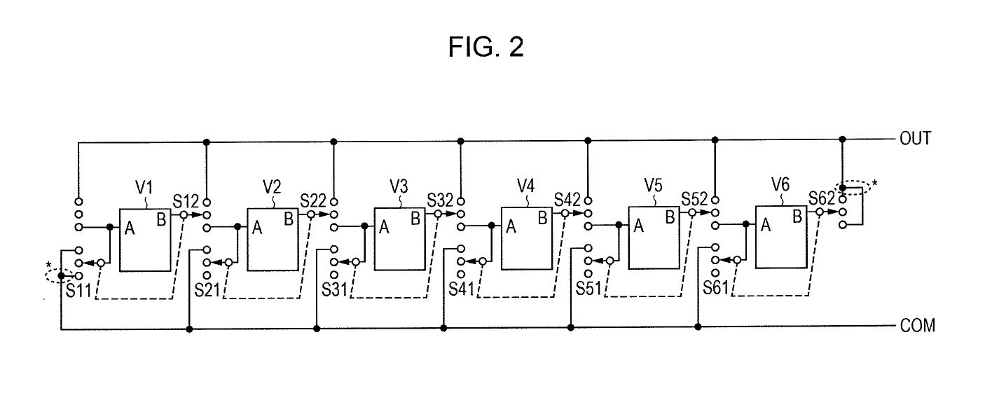

FIG. 2 is an explanatory diagram that shows a configuration example of the series-parallel switching system 10 according to the first embodiment of the present disclosure for switching the connection form of a plurality of electric power sources such as a solar battery. Hereinafter, a configuration example of the series-parallel switching system 10 according to the first embodiment of the present disclosure will be described using FIG. 2.

As shown in FIG. 2, the series-parallel switching system 10 according to the first embodiment of the preset disclosure includes electric power sources V1 to V6, and switches S11, S12, . . . , S61, and S62. The series and parallel connections of the electric power sources V1 to V6 are realized by the switching of the switches S11, S12, . . . , S61, and S62. When setting the electric power sources V1 to the DC power source and OUT to + output, A of the electric power source V1 is − input terminal, and B is + output terminal. Of course, + and − may be completely reversed. Furthermore, even when the electric power source V1 is not the DC power source but an AC power source, the frequency or the phase is aligned, the system can be operated like the series-parallel switching system 10 according to the first embodiment of the present disclosure shown in FIG. 2.

In addition, dotted lines between switches S11 and S12 in FIG. 2 mean that the switches S11 and S12 are operated in conjunction with each other. The same is also true for the dotted lines between other switches shown in FIG. 2.

The basic structure is constituted by the same unit, but as shown in FIG. 2, a starting point (the left end) of the electric power source is the series and parallel, and it is necessity that the point A is connected to the GND. In this manner, a final end (the right end) of the electric power source is not limited to the series and the parallel, and the point B is connected to OUT.

As mentioned above, the configuration example of the series-parallel switching system 10 according to the first embodiment of the present disclosure was described using FIG. 2. Next, the change of the connection form of the electric power source included in the series-parallel switching system 10 according to the first embodiment of the present disclosure will be described with reference to the drawings.

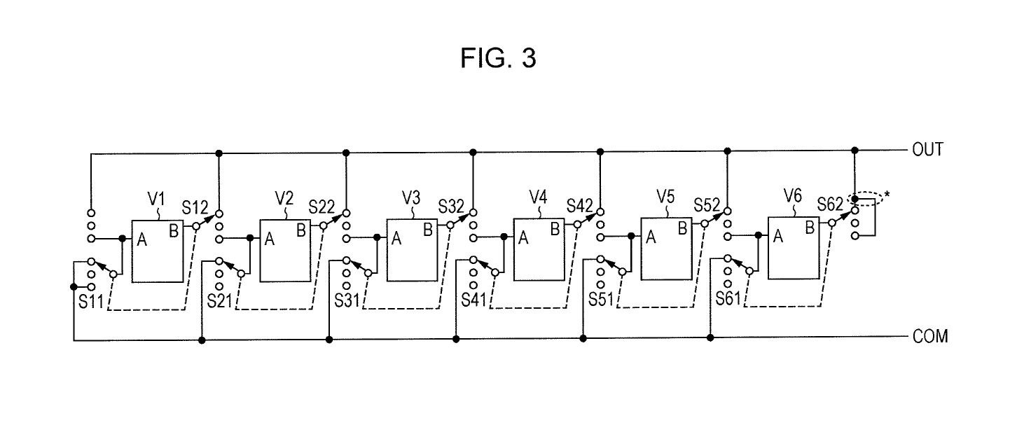

FIG. 3 is an explanatory diagram that shows a case where all of the electric power sources V1 to V6 are connected in parallel in the series-parallel switching system 10 according to the first embodiment of the present disclosure shown in FIG. 2. By setting the switches S11, S12, . . . , S61, and S62 so as to be connected to each other as shown in FIG. 3, all of the electric power sources V1 to V6 are connected to each other in parallel. The switching of the switch may be, for example, remotely operated by the sending of a switch switching command from the outside of each power source. In this manner, by remotely operating each switch, it is possible to dynamically change the connection forms of each power source depending on the change in output without the necessity for switching of complicated wirings. In addition, at this time, practically, there is the necessity for the precondition in which the voltages of the electric power sources V1 to V6 are aligned or the like, but, herein, the first question is topology. The same is also true for the description as below.

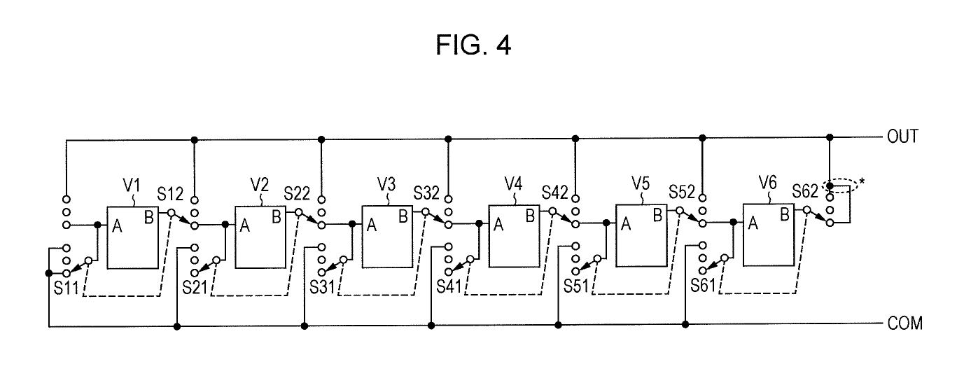

FIG. 4 is an explanatory diagram that shows a case where all of the electric power sources V1 to V6 are connected in series in the series-parallel switching system 10 according to the first embodiment of the present disclosure shown in FIG. 2. By setting the switches S11, S12, . . . , S61, and S62 so as to be connected to each other as in FIG. 4, all of the electric power sources V1 to V6 are connected to each other in series. Herein, the switch S62 is different from other corresponding portions in the connection. This is because the output can be obtained from the OUT terminal in both of the series and the parallel in the final end of the output.

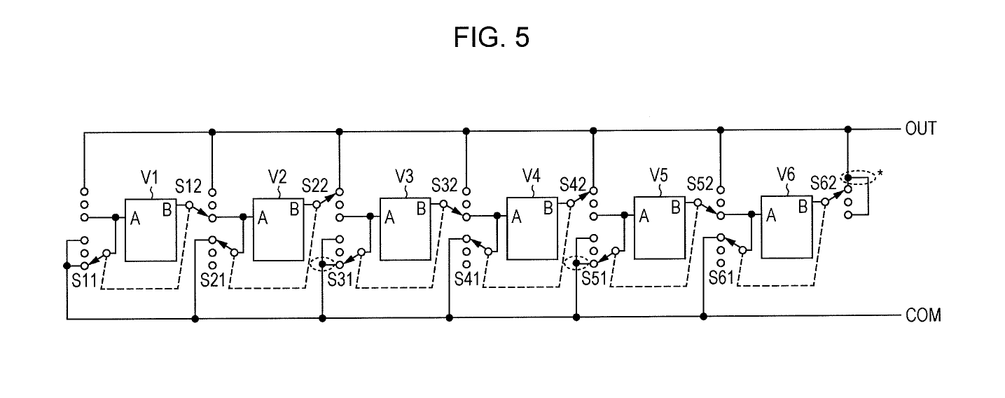

FIG. 5 is an explanatory diagram that shows a case where the electric power sources V1 and V2 are connected to each other in series, the electric power sources V3 and V4 are connected to each other in series, the electric power sources V5 and V6 are connected to each other in series, and the electric power sources connected in series are connected to each other in parallel in the series-parallel switching system 10 according to the first embodiment of the present disclosure shown in FIG. 2. By setting the switches S11, S12, . . . , S61, and S62 so as to be connected to each other as in FIG. 5, the electric power sources V1 to V6 are connected such that the electric power sources V1 and V2 are connected to each other in series, the electric power sources V3 and V4 are connected to each other in series, the electric power sources V5 and V6 are connected to each other in series, and then the electric power sources connected in series can be connected to each other in parallel.

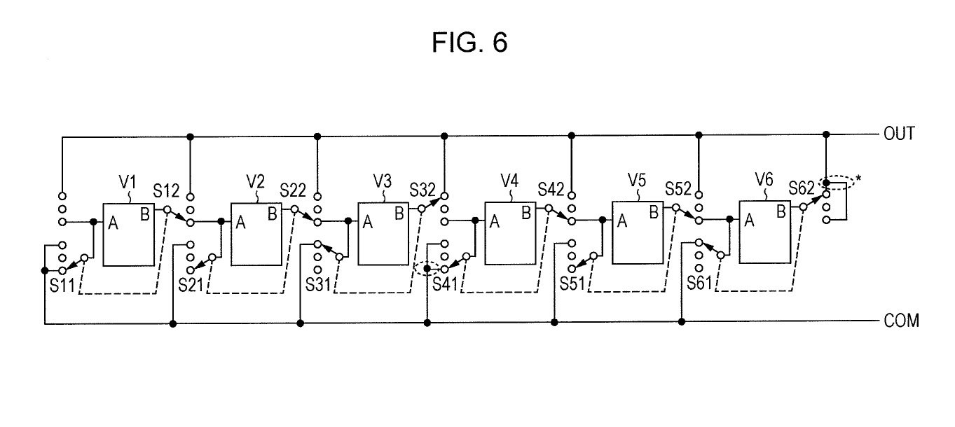

FIG. 6 is an explanatory diagram that shows a case where the electric power sources V1, V2, and V3 are connected to each other in series, the electric power sources V4, V5, and V6 are connected to each other in series, and the electric power sources connected in series are connected to each other in parallel in the series-parallel switching system 10 according to the first embodiment of the present disclosure shown in FIG. 2. By setting the switches S11, S12, . . . , S61, and S62 so as to be connected to each other like FIG. 6, the electric power sources V1 to V6 are connected such that the electric power sources V1, V2 and V3 are connected to each other in series, the electric power sources V4, V5, and V6 are connected to each other in series, and then the electric power sources connected in series can be connected to each other in parallel.

In this manner, it is possible to easily switch the connection states of the electric power sources V1 to V6 between series and parallel by controlling the connection of the switches S11, S12, . . . , S61, and S62.

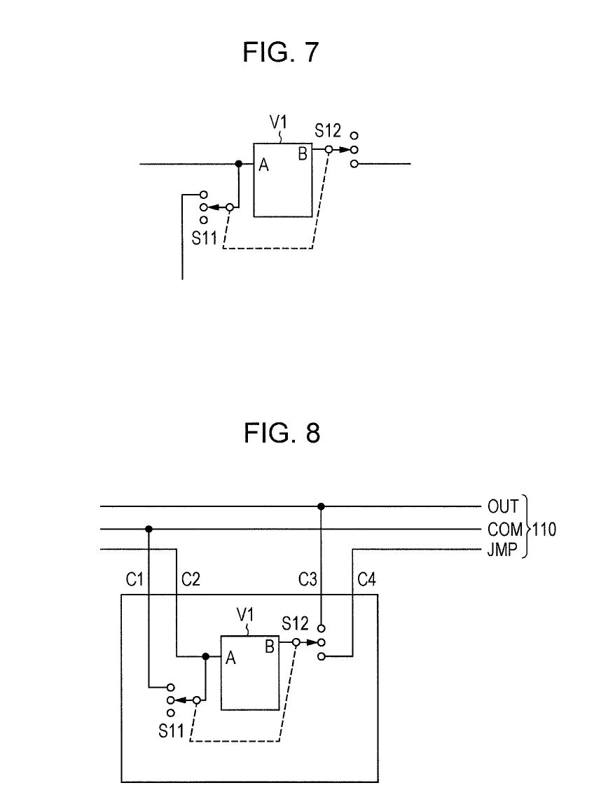

Herein, it is difficult to understand that the series-parallel switching system 10 according to the first embodiment of the present disclosure shown in FIG. 2 can be realized as the bus line in this manner. Thus, it is described that the series-parallel switching system 10 according to the first embodiment of the present disclosure shown in FIG. 2 can be realized as the bus line. FIG. 7 is an explanatory diagram that extracts and shows an electric power source and a switch included in the series-parallel switching system 10 according to the first embodiment of the present disclosure shown in FIG. 2. That is, in FIG. 7, an electric power source Vn, and switches Sn1 and Sn2 (n=1, 2, 3, 4, 5, and 6) are components.

FIG. 8 is an explanatory diagram showing that the components shown in FIG. 7 and the bus line are separated from each other, and the bus line 110 and the connection points C1, C2, C3, and C4 between the bus line 110 and the electric power source V1 are clearly indicated.

As shown in FIG. 8, it is understood that the electric power source V1 is connected to the bus line 110 and the connection points C1, C2, C3, and C4, and the bus line 110 connected to the electric power source V1 are at least three lines of output (OUT), common (COM), and adjacent connection (JMP) lines.

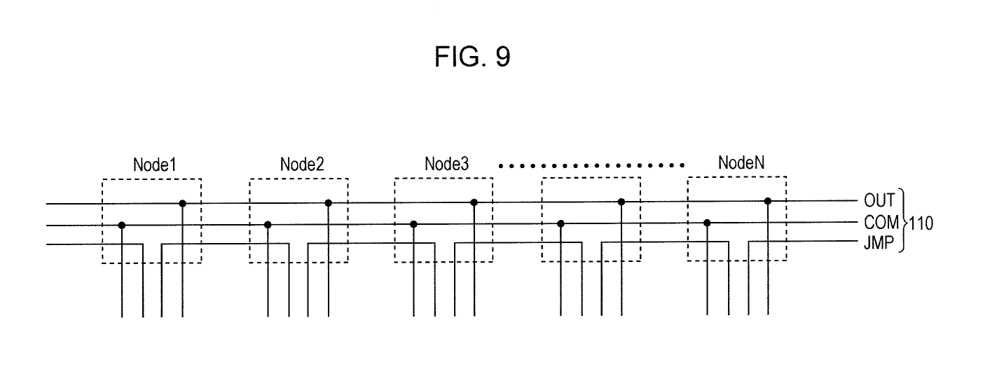

FIG. 9 is an explanatory diagram that shows a configuration of the bus line 110 side in the series-parallel switching system 10 according to the first embodiment of the present disclosure shown in FIG. 2. In addition, the electric power source V1 is omitted in FIG. 9.

As shown in FIG. 9, the bus line is basically configured by three electric power lines, and four connection points (Nodes) with the unit are necessary. That is, if there are 3 bus lines and a node by a four pin connector, the basic control of the series and parallel connections of the electric power source can be performed. In addition, since one of three bus lines is used in the connection with the near electric power source, the bus line is not a continuous line. The bus line is constituted in this manner, whereby, for example, it is able to completely perform the switching of the series and parallel connections of the six electric power sources as mentioned above, and even if the number thereof is increased to 12, the number of bus lines or the number of pins of the connector may be identical to each other.

However, it is difficult to skip the adjacent electric power source or connect the electric power source, which is connected in series, in parallel in a box shape after skipping the adjacent electric power source.

In the series-parallel switching system 10 according to the first embodiment of the present disclosure described above, by remotely switching the switches S11, S12, . . . , S61, and S62 manually or by a certain unit, the series-parallel switching of the electric power sources V1 to V6 is performed. As a result, the series-parallel switching system 10 according to the first embodiment of the present disclosure can switch the connection forms of the plurality of electric power sources to the series and the parallel without using complicated wirings.

### 3. Second Embodiment of the Present Disclosure

Next, a second embodiment of the present disclosure will be described with reference to the drawings. In the second embodiment of the present disclosure described below, a DC electric power source is assumed as the electric power source. This is because electric power source from natural energy, such as a solar battery or biomass, is DC, and, further, even in current such as from wind power (as generated), the voltage and frequency are inconsistent, and may be conveniently handled once converted to DC. However, the time-varying DC is not considered as the DC+AC.

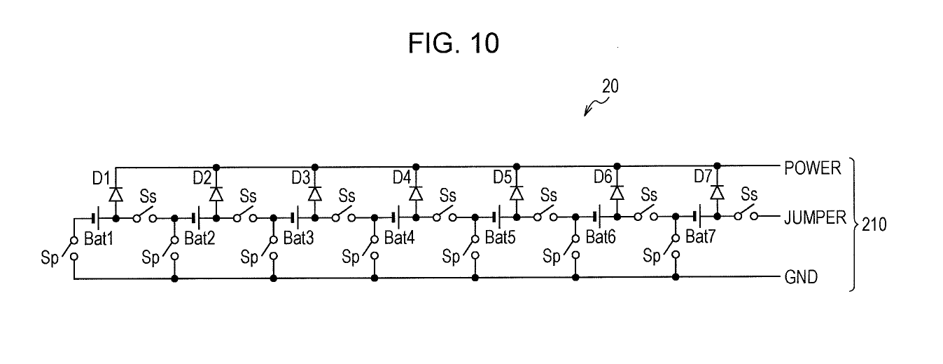

FIG. 10 is an explanatory diagram that shows a configuration example of a series-parallel switching system 20 according to the second embodiment of the present disclosure. Hereinafter, the configuration example of the series-parallel switching system 20 according to the second embodiment of the present disclosure will be described using FIG. 10.

In the series-parallel switching system 20 according to the second embodiment of the present disclosure shown in FIG. 10, the switch is replaced with two switches using a semiconductor. Furthermore, as shown in FIG. 10, a diode is included which is operated during parallel connection but is cut off during series. By combining the switch with the diode in this manner, there is an advantage in that that the configuration is simplified and the control is easy. Moreover, the respective batteries Bat1 to Bat7 are connected onto a bus line 210 of three lines that includes output (OUT), common (COM), and adjacent connection (JMP) lines.

It is clear from FIG. 10 that the batteries Bat1 to Bat7 as the plurality of DC electric power sources can be controlled in any of all parallel, all series, three parallel connections of as series of two, two parallel connections of a series of three.

Meanwhile, when the electric power source is connected by setting the switch as a mechanical switch, a switch opened can also be used. For example, since a connector is used in the connection between the electric power sources, a switch such as a micro switch opened upon being inserted is used.

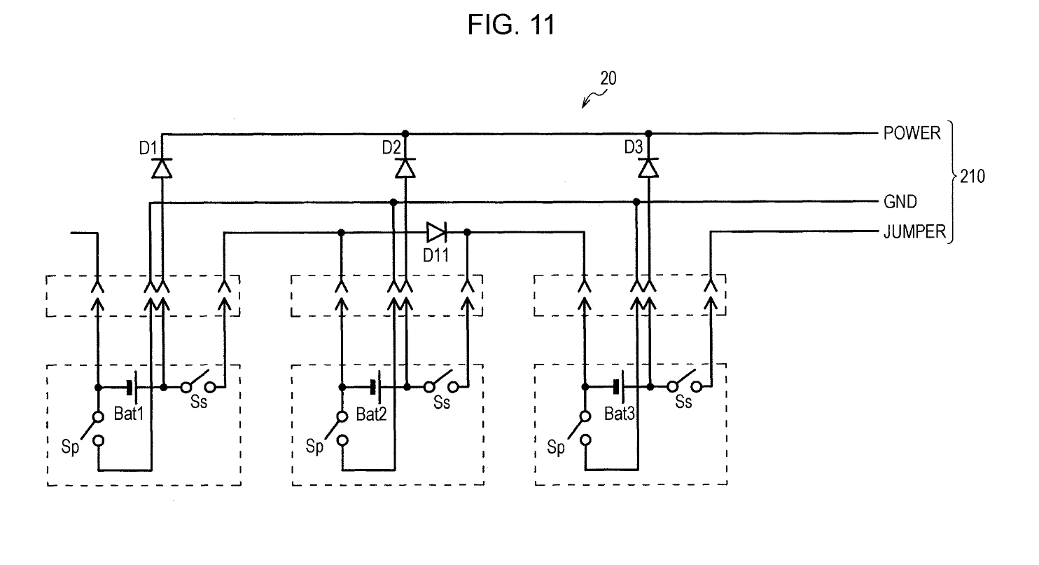

FIG. 11 is an explanatory diagram that shows the series-parallel switching system 20 according to the second embodiment of the present disclosure shown in FIG. 10 by a form in which the bus line 210 and the electric power source connected to the bus line 210 are set as a unit. It is also clear that the configuration shown in FIG. 11 can be controlled by the parallel connection, the series connection, three parallel connections of a series of two, and two parallel connections of a series of three.

The diodes D1, D2, and D3 shown in FIG. 11 are diodes that are inserted such that the series connection is possible even when the unit is removed, and in this respect, the diodes have advantages over the series-parallel switching system 10 according to the first embodiment of the present disclosure mentioned above. When the unit is connected to the bus line and the series mode is set, the diodes D1, D2, and D3 have a reversal bias due to the electromotive force of the unit itself, and are not operated. Furthermore, in the parallel mode, the operation is originally unrelated. When the diodes D1, D2, and D3 are not present, any unit is removed, or in the case of being completely off even when the unit is connected (that is, neither the series nor the parallel), it is difficult to perform the series connection with the unit interposed therebetween.

In addition, the diodes D1, D2, and D3 shown in FIG. 11 may be mechanical contacts that become OFF when the unit is connected. In this case, in a structure in which the mechanical contact is ON when the connector is removed, a mechanism can be used which is, for example, used in an earphone jack with a switch or the like.

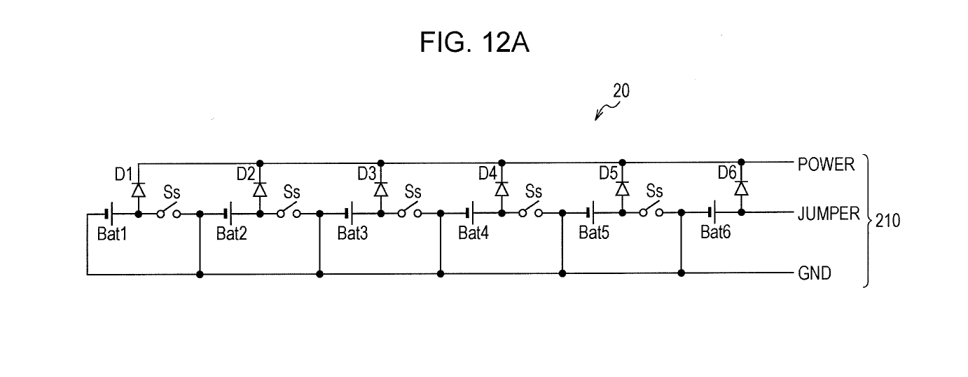

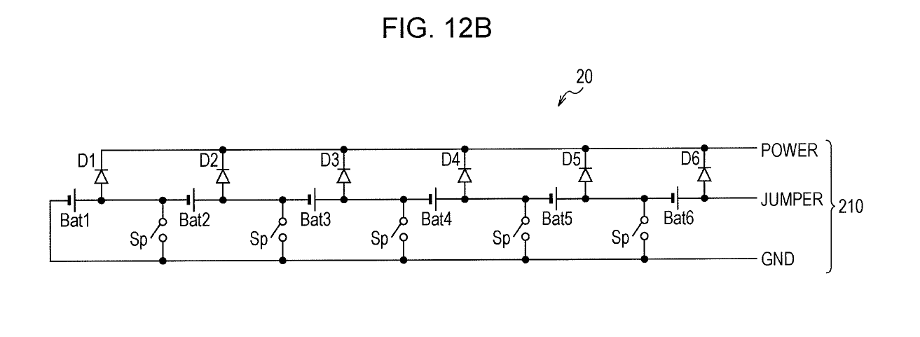

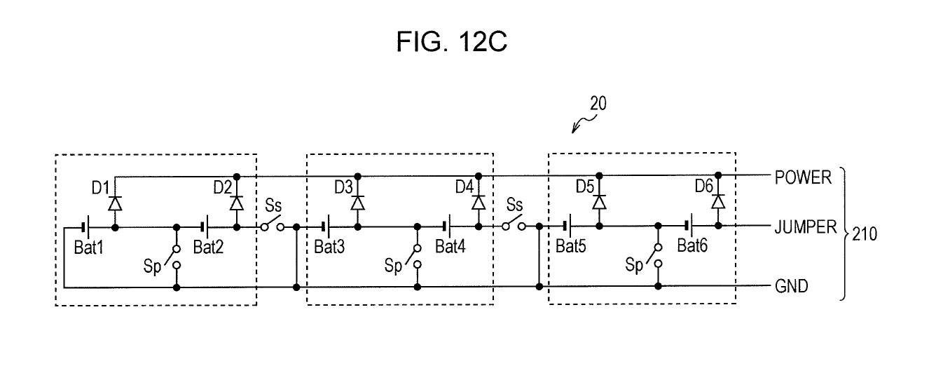

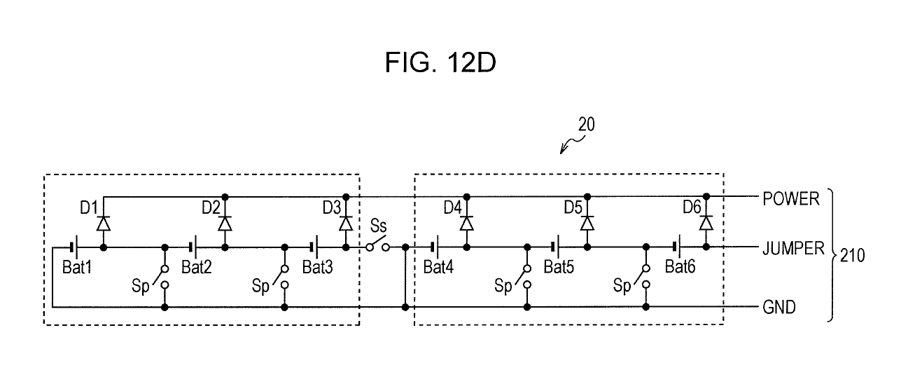

FIGS. 12A to 12D are explanatory diagrams that show the series-parallel connection by the series-parallel switching system 20 according to the second embodiment of the present disclosure.

FIG. 12A shows the state in which all the electric power sources are connected in parallel, FIG. 12B shows the state in which all the electric power sources are connected in series, FIG. 12C shows the state in which the electric power source of two series is connected in three parallel, and FIG. 12D shows the state in which the electric power source of three series is connected in two parallel, respectively. In this manner, in the series-parallel switching system 20 according to the second embodiment of the present disclosure, it is also understood that the dynamic switching of the series-parallel of the electric power source is possible.

In addition, FIGS. 12A to 12D show the case where there are six electric power sources, but the present disclosure is not limited to the example. In general, it is needless to say that n number of units can be subjected to the series-parallel connection without increasing the number of bus lines.

### 4. Third Embodiment of the Present Disclosure

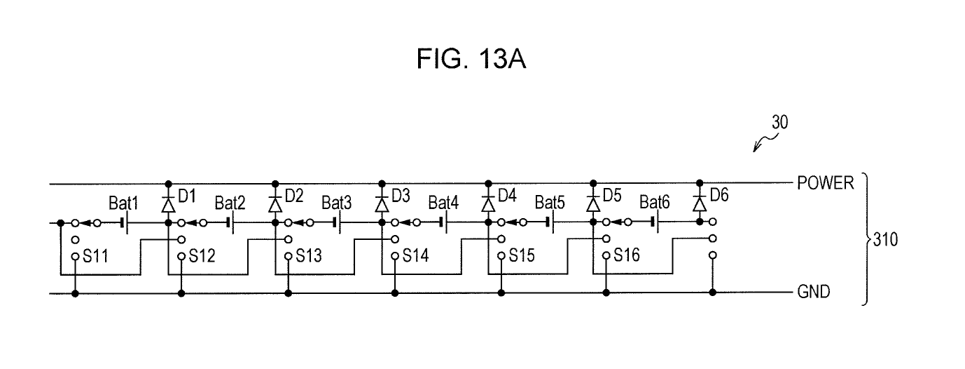

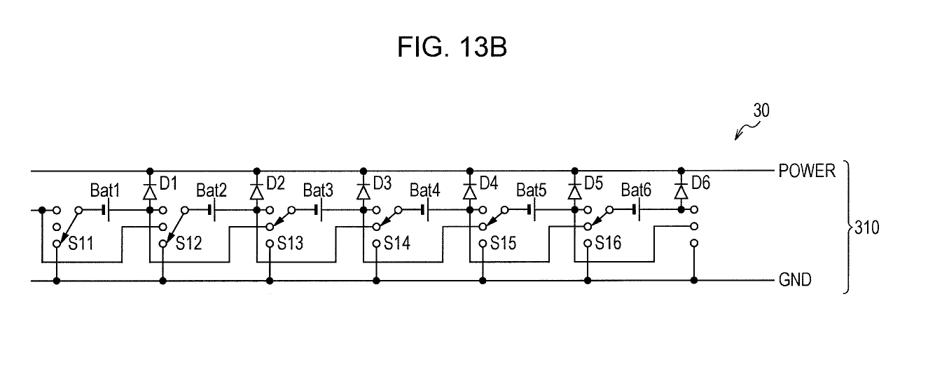

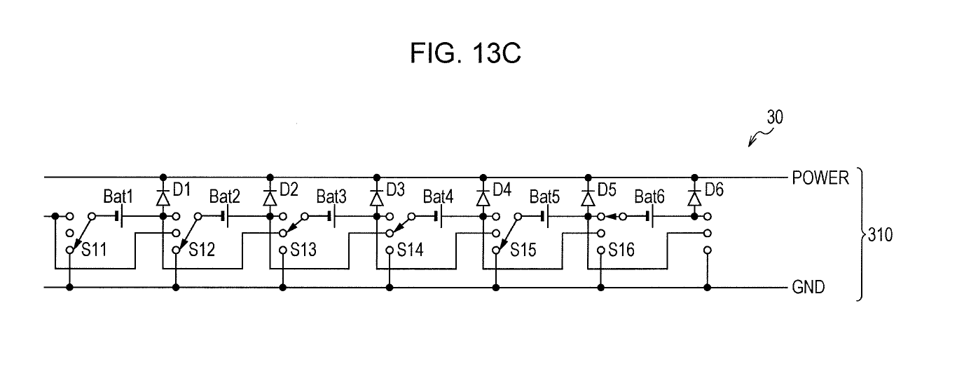

Next, a third embodiment of the present disclosure will be described with reference to the drawings. In the third embodiment of the present disclosure, a series connection is possible in which the electric power source has a box structure. FIGS. 13A to 13C are explanatory diagrams that show the configuration example of a series-parallel switching system 30 according to the third embodiment of the present disclosure. Hereinafter, the configuration example of the series-parallel switching system 30 according to the third embodiment of the present disclosure will be described using FIGS. 13A to 13C.

FIG. 13A is a basic structure of the configuration example of the series-parallel switching system 30 according to the third embodiment of the present disclosure. FIG. 13A shows a case where six batteries Bat1 to Bat6 are connected to each other in series by connecting the switches S11 to S16 as shown. In the respective batteries Bat1 to Bat6, switching switches SW11 to SW16 of three contacts are provided, and by switching over the switches SW11 to SW16, the connection forms of the batteries Bat1 to Bat6 can be switched. In addition, as shown in FIG. 13A, in the series-parallel switching system 30 according to the third embodiment of the present disclosure, six batteries Bat1 to Bat6 are connected to a bus line 310 which includes a POWER line and a GND line.

Furthermore, in the series-parallel switching system 30 according to the third embodiment of the present disclosure, diodes (herein, six diodes D1 to D6) depending on the number of the battery are provided. The series-parallel switching system 30 according to the third embodiment of the present disclosure prevents the inflow of the electric current from any battery to another battery by the diodes D1 to D6.

In FIG. 13B, by connecting the switches S11 to S16 as shown, the batteries Bat1, Bat3, and Bat5 are connected to each other in series, the batteries Bat2, Bat4, and Bat6 are connected to each other in series, respectively, and then those are connected to each other in parallel.

In FIG. 13C, by connecting the switches S11 to S16 as shown, the batteries Bat1 and Bat3 are connected to each other in series, the batteries Bat2 and Bat4 are connected to each other in series, and the batteries Bat5 and Bat6 are connected to each other in series, respectively, and then those are connected to each other in parallel.

In addition, in the series-parallel switching system 30 according to the third embodiment of the present disclosure, there is provided a box structure in which only one unit is a bypass but not a box structure in which the two units (the batteries) are bypasses. In order to make two units the bypass, it is necessary to further increase the bypass line and the contact of the switching switch by one system, whereby the bus structure is possible, but the number of bus lines is increased, and the practicality is reduced. Thus, herein, only the description is provided in which the box structure of two or more units, and the development of an actual bus structure is omitted.

### 5. Fourth Embodiment of the Present Disclosure

Next, a fourth embodiment of the present disclosure will be described with reference to the drawings. In the fourth embodiment of the present disclosure, control and communication sections of each unit are added to the second embodiment of the present disclosure mentioned above.

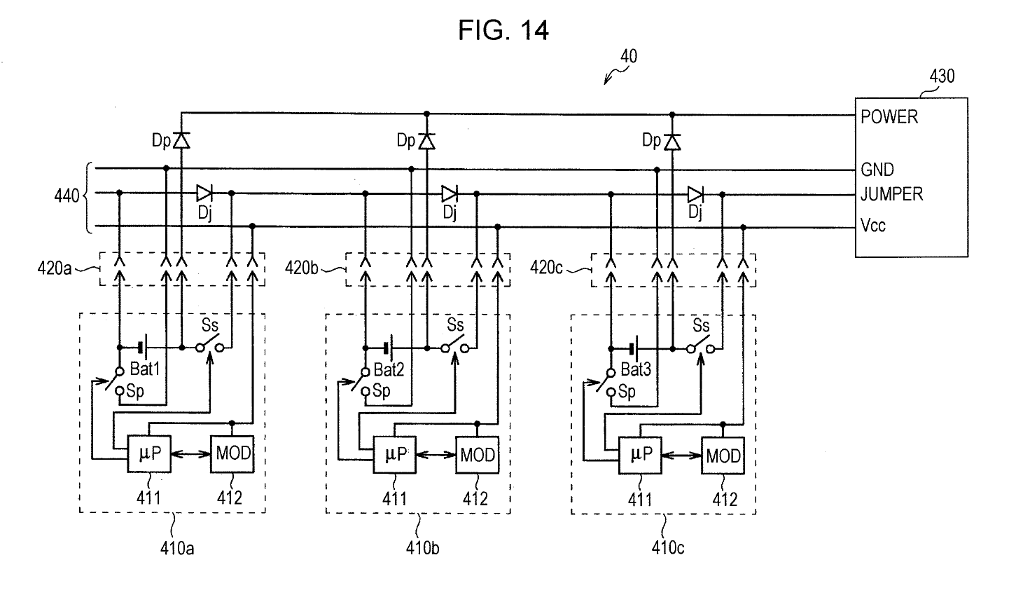

FIG. 14 is an explanatory diagram that shows a configuration example of a series-parallel switching system 40 according to the fourth embodiment of the present disclosure. Hereinafter, the configuration example of the series-parallel switching system 30 according to the fourth embodiment of the present disclosure will be described using FIG. 14.

FIG. 14 shows a bus line 440 in which, in the configuration of the series-parallel switching system 20 according to the second embodiment of the present disclosure shown in FIG. 11, a microprocessor 411 for controlling the on-off states of the internal switch, and a modem 412 for executing the communication are provided in each unit (battery devices 401a, 401b, and 410c), a common line for supplying the constant operation electric power to the microprocessor 411 and the modem 412 from a system control device 430 is added.

In the series-parallel switching system 40 according to the fourth embodiment of the present disclosure, as shown in FIG. 14, there are four bus lines 440. Auxiliary electric power added to the series-parallel switching system 40 according to the fourth embodiment of the present disclosure supplies a relatively small electric power to the microprocessor. Of course, when the unit shown in FIG. 14 is the electric power source for generating the electric power but not the battery devices 410a, 410b, and 410c like the present embodiment, it is also possible to obtain the electric power of the microprocessor or the like from now. Meanwhile, upon considering the startup from the case where there is no electric power at all, it is convenient that the electric power for the start-up is supplied from the outside.

Furthermore, the fourth lines applied to the series-parallel switching system 40 according to the fourth embodiment of the present disclosure is also used as a communication line by the superimposition of the signal modulated at high frequency. It is also possible to use an electric power OUT line (the POWER line in FIG. 14) as the communication line, but, in this case, it is desirable to insert a condenser having a small capacity into the diode, so that the diode portion conducts in both directions at high frequency. In addition, there are cases where the communication line can be replaced with the capacity of the reversal bias of the diode.

Among four bus lines shown in FIG. 14, the COM line is common to all bus lines and is used generally as the GND line. Furthermore, a Jumper line is unnecessary for the system control device 430 and can be omitted.

The bus line has the directivity to the electric power, and in the case of the configuration as shown in FIG. 14, the electric power can only be sent from the left side to the right side of FIG. 14. Furthermore, at the end of the bus line, a battery charger and the system control device 430 for controlling the entire system are provided. The system control device 430 controls the series and the parallel of the electric power source connected to each node.

Thus, the system control device 430 and each unit (the battery devices 401a, 401b, and 410c) perform the communication, the system control device 430 performs the existence confirmation of the electric power source (the battery devices 401a, 401b, and 410c) on the bus line, and performs the management thereof. However, since the points of the present embodiment are the topology of the electric power source and the control device and the series-parallel control, the details thereof will be omitted.

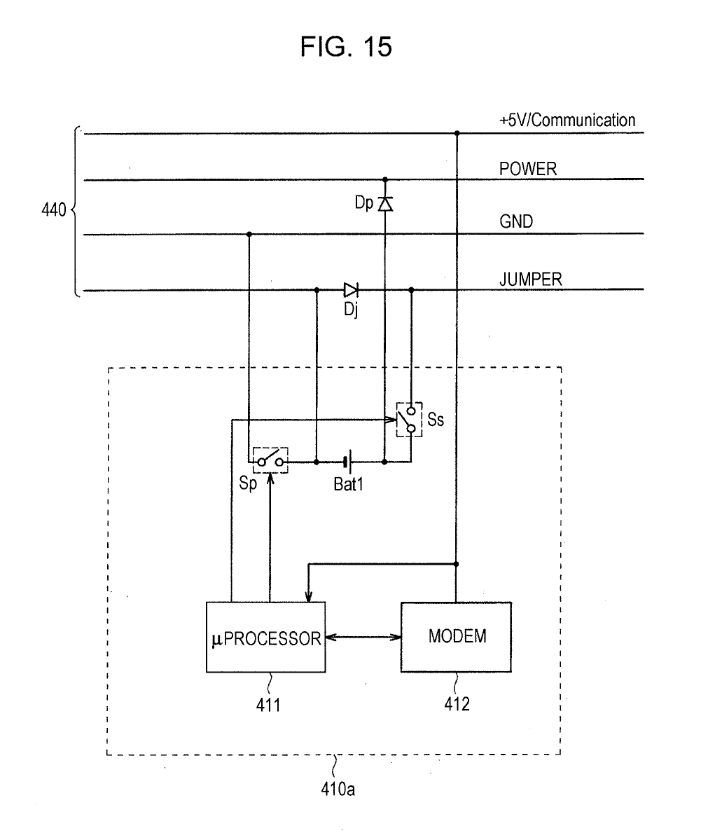

FIG. 15 is an explanatory diagram that shows an inner portion of a unit (the battery device 410a) as the component of the series-parallel switching system 40 according to the fourth embodiment of the present disclosure by a functional block.

As shown in FIG. 15, the battery device 410a as the component of the series-parallel switching system 40 according to the fourth embodiment of the present disclosure includes a microprocessor 411, a modem 412, switches Sp and Ss, and a battery Bat1.

The modem 412 communicates with the system control device 430 shown in FIG. 14. The modem 412 can receive information (the timing of on-off or the like) for controlling on-off of the switches Ss and Sp from the system control device 430. Furthermore, the microprocessor 411 controls the operation of the inner portion of the battery device 410a, particularly, on-off of the switches Ss and Sp. The microprocessor 411 executes on-off of the switches Ss and Sp based on information received by the modem 412. Herein, the switch Ss is a series switch and the switch Sp is a parallel switch.

+5 V/Communication line shown in FIG. 15 is a communication line between the system control device 430 and the modem 412, and the system control device 430 and the modem 412 can execute the transmission and the reception of information superimposed on the electric power. In addition, an inductance is inserted between +5 V/Communication line and the battery device 410a, so that impedance is not excessively lowered with respect to the high frequency signal.

Furthermore, the diode Dp is an output diode during parallel connection, and the diode Di is a series bypass diode. The diode Dp can also be built in the battery device 410a. Meanwhile, it is desirable that the diode Dj be connected to the bus line side.

By constituting the battery device 410a as shown in FIG. 15, it is possible to control the opening and closing of the switches Ss and Sp by the control from the system control device 430. Moreover, by controlling the open and close of the switches Ss and Sp by the control from the system control device 430, it is possible to switch the connection form of the unit between series and parallel by the remote control.

### 6. Fifth Embodiment of the Present Disclosure

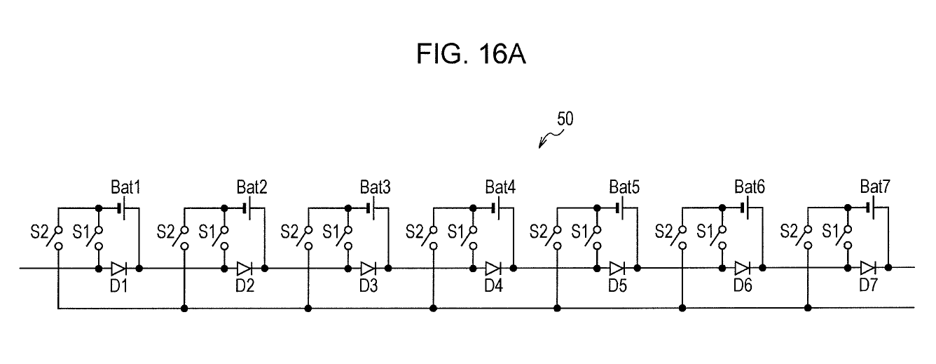

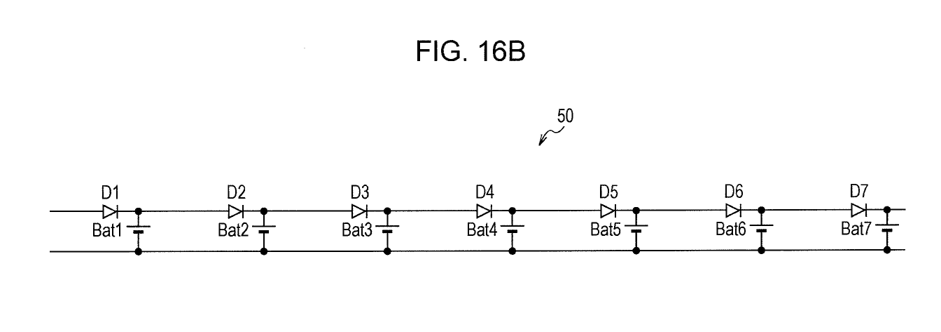

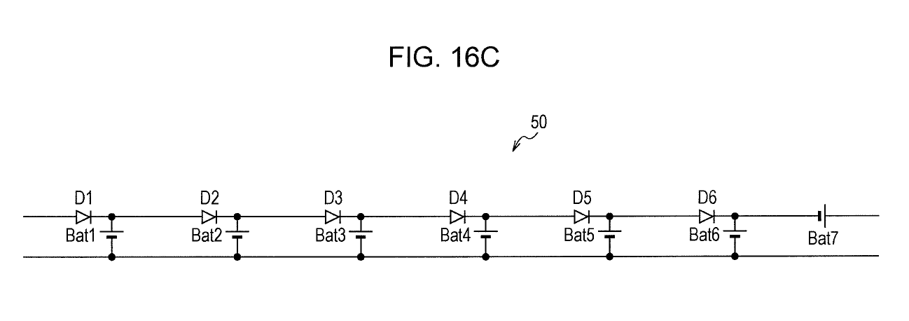

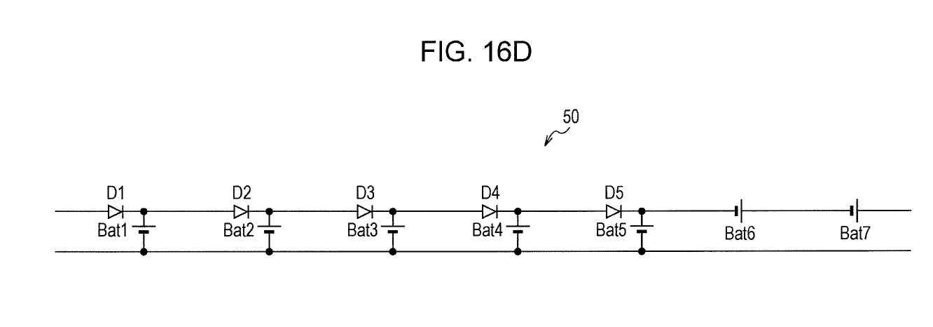

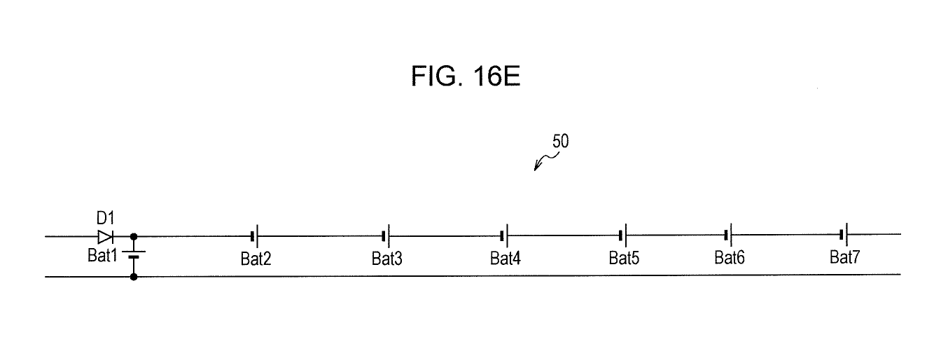

Next, a fifth embodiment of the present disclosure will be described with reference to the drawings. FIGS. 16A to 16E are explanatory diagrams that show configuration examples of a series-parallel switching system 50 according to a fifth embodiment of the present disclosure. Hereinafter, the configuration example of the series-parallel switching system 50 according to the fifth embodiment of the present disclosure will be described with reference to FIGS. 16A to 16E.

The series-parallel switching system 50 according to the fifth embodiment of the present disclosure is a system in which a plurality of electric power sources and switches has the configuration of FIG. 16A. By suitably switching the switch shown in FIG. 16A, the series-parallel states of the plurality of electric power sources can be switched.

As shown in FIG. 16A, the series-parallel switching system 50 according to the fifth embodiment of the present disclosure includes batteries Bat1 to Bat7, switches S1 and S2, and diodes D1 to D7. By switching on-off of the switches S1 and S2, the connections of the batteries Bat1 to Bat7 can be switched between series and parallel.

In addition, in regard to on-off stages of the switches S1 and S2, like the fourth embodiment of the present disclosure mentioned above, on-off thereof may be controlled by the wired or wireless communication. By controlling on-off of the switches S1 and S2 by the wired or wireless communication, it is possible to switch over the communication forms of the batteries Bat1 to Bat7 by the remote control.

FIG. 16B shows a case where all the electric power sources are connected to each other in parallel in the series-parallel switching system 50 according to the fifth embodiment of the present disclosure. In this case, a diode is inserted into the left electric power source in series. Furthermore, FIG. 16C shows a case where one electric power source is connected in series in connecting the (n-1) electric power source is connected in parallel. Furthermore, FIG. 16D shows a case where two electric power sources are connected to each other in series in connecting the (n-2) electric power source is connected in parallel. Moreover, FIG. 16E shows a case where all the electric power sources are connected to each other in series.

In the type such as the series-parallel switching system 50 according to the fifth embodiment of the present disclosure, it is difficult to realize the series-parallel shown in FIG. 5, but the type can be applied to a case where the electric power source (or the load) is connected in series one by one.

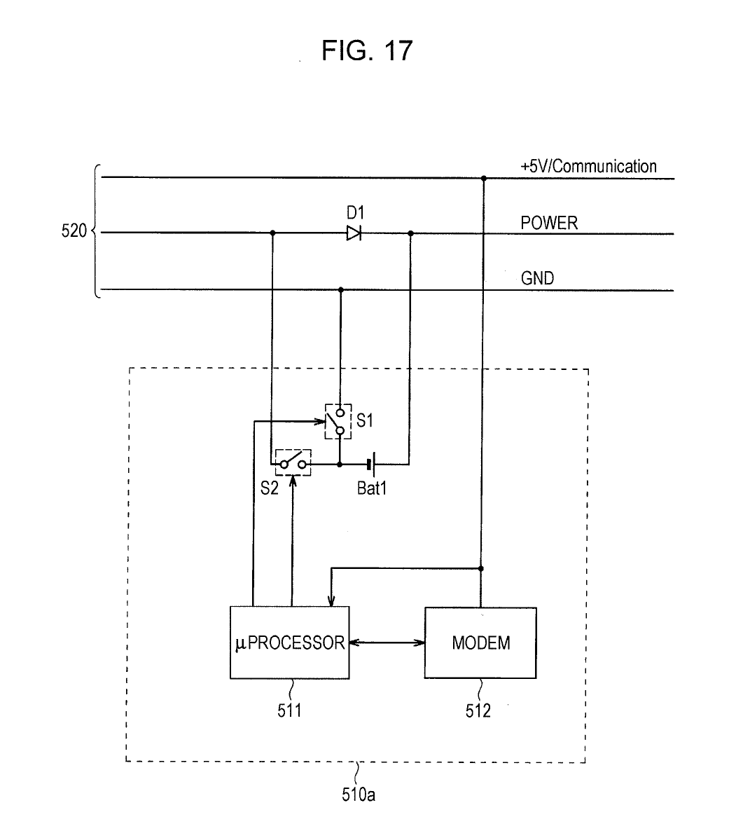

FIG. 17 is an explanatory diagram that shows a bus line 520 of the series-parallel switching system 50 and a unit structure according to the fifth embodiment of the present disclosure shown in FIGS. 16A to 16E. The series-parallel switching method of the unit by the series-parallel switching system 50 according to the fifth embodiment of the present disclosure is reduced in the number of bus lines 520 compared to the series-parallel switching system 40 according to the fourth embodiment of the present disclosure, and there is an advantage in that the series-parallel switching method can be constituted by two bus lines except for the electric power supply (and the communication) line. At this time, the communication signal may be superimposed on the POWER line. In addition, in this case, a high frequency bypass condenser to the diode D may be provided.

Furthermore, the pin number of bus lines and the connector may also be four even in the case of using the constant power source line. Moreover, the switches S1 and S2 may also use switches that use a mechanical relay and a MOS semiconductor.

### 7. Conclusion

As described above, according to each embodiment of the present disclosure, it is possible to provide a system which enables the series and parallel control of the electric power source by the use of the relatively small number of bus lines. As a result, for example, an arbitrary number of solar batteries are connected to the bus line, and the series-parallel is dynamically switched over depending on the output voltage thereof, whereby it is possible to provide a solar battery, the electricity generation in which the sunshine situation is fully used, or the charge to the electric power battery.

At present, an intelligent battery server is actively being developed, but each embodiment of the present disclosure can provide a very extensive method to a charge side of the intelligent battery server and become a basic technique of future distributed-type or individual base electric power systems which are applied to natural power.

The present disclosure contains subject matter related to that disclosed in Japanese Priority Patent Application JP 2010-254197 filed in the Japan Patent Office on Nov. 12, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A series-parallel switching system comprising:
two or more electric power supply sources;
two or more first switches that are provided so as to correspond to the respective electric power supply sources and connect the two or more electric power supply sources to each other in series; and
two or more second switches that are provided so as to correspond to the respective electric power supply sources and connect the two or more electric power supply sources to each other in parallel,
wherein pairs of two or more first switches and two or more second switches are each independently switched,
the two or more electric power supply sources are connected to a bus line that includes at least a first bus line each commonly connected to an electric power input side of each electric power supply source and a second bus line each commonly connected to an electric power output side of each electric power supply source, and
by switching over the first switches and the second switches using the switch switching portion, the first switches and the second switches are connected to the first bus line and the second bus line or are separated from the first bus line and the second bus line, and the connection of the electric power supply device is changed over to series and parallel.

2. The series-parallel switching system according to claim 1,
wherein the electric power supply sources further include a switch switching instruction portion that instructs the switching of the first switches and the second switches.

3. The series-parallel switching system according to claim 2,
wherein the electric power supply sources further include a modem which executes the communication of information on the switching of the first switches and the second switches, and
the modem notifies information received by the communication of information on the switching to the switch switching instruction portion, and the switch switching instruction portion instructs the switching of the first switches and the second switches based on information received from the modem.

4. The series-parallel switching system according to claim 3,
wherein the modem receives information on the switching superimposed on the electric power.

5. The series-parallel switching system according to claim 1,
wherein the bus line further includes a third bus line that connects the output side with the input side between the electric power supply sources, and
the first switches and the second switches are provided on the third bus line.

6. The series-parallel switching system according to claim 1, further comprising:
an electric power supply control device that executes the communication of information on the switching between the series-parallel switching system and the modem.

7. The series-parallel switching system according to claim 1,
wherein the electric power supply source is a solar battery module.

8. An electric power supply device comprising:
a first switch for being connected to another electric power supply source in series;
a second switch for being connected to another electric power supply source in parallel; and
a modem which executes the communication of information on the switching of the first switch and the second switch,
wherein pairs of two or more first switches and two or more second switches are each independently switched,
another electric supply source is connected to a bus line that includes at least a first bus line each commonly connected to an electric power input side of another electric power supply source and a second bus line each commonly connected to an electric power output side of another electric power supply source, and
the modem notifies information received by the communication of information on the switching to the switch switching instruction portion, and the switch switching instruction portion instructs the switching of the first switches and the second switches based on information received from the modem.

9. The electric power supply device according to claim 8,
wherein the modem receives information on the switching superimposed on the electric power.

10. The electric power supply device according to claim 8,
wherein the electric power supply source is a solar battery module.

11. An electric power supply control device comprising:
a first switch that is provided so as to correspond to each electric power supply source for being connected to another electric power supply source in series;
a second switch that is provided so as to correspond to each electric power supply source for being connected to another electric power supply source in parallel;
a switch switching instruction portion that instructs the switching of the first switch and the second switch; and
a modem which executes the communication of information on the switching of the first switch and the second switch,
wherein the communication of information on the switching is executed between the electric power supply control device and an electric power supply device connected to a bus line that includes at least a first bus line each commonly connected to an electric power input side of another electric power supply source and a second bus line each commonly connected to an electric power output side of another electric power supply source.

12. The electric power supply control device according to claim 11,
wherein information on the switching is superimposed on the electric power to perform the communication between the electric power supply control device and the modem.

13. A series-parallel switching method, in a series-parallel switching system which includes
two or more electric power supply sources;
two or more first switches that are provided so as to correspond to the respective electric power supply sources and connect the two or more electric power supply sources to each other in series; and
two or more second switches that are provided so as to correspond to the respective electric power supply sources and connect the two or more electric power supply sources to each other in parallel,
wherein pairs of two or more first switches and two or more second switches are each independently switched, the two or more electric power supply sources are connected to a bus line that includes at least a first bus line each commonly connected to an electric power input side of each electric power supply source and a second bus line each commonly connected to an electric power output side of each electric power supply source,
the method comprising series-parallel switching that switches the connection to the electric power supply device between series and parallel by switching over the first switches and the second switches using the switch switching portion.
